(19) United States
(12) Patent Application Publication
(10) Pub. No.: US 2002/0139894 A1
(43) Pub. Date: Oct. 3, 2002

(54) Roadable aircraft boat that flies in a wind of its own making

(76) Inventor: Bradford T. Sorensen, Los Angeles, CA (US)

Correspondence Address: Bradford T. Sorensen, One University Drive, P.O. Box 2870, Camarillo, CA, 93012, US

(21) Appl. No.: 10/057,194

(22) Filed: Jan. 25, 2002

Related U.S. Application Data
(60) Provisional application No. 60/265,733, filed on Feb. 1, 2001.

(51) Int. Cl. B64C 37/02; B64D 5/00

(52) U.S. Cl. 244/2

(57) ABSTRACT

An improved VTOL aircraft or flying car mechanism that utilizes counter-rotating blades (18) spinning inside a duct (14) causing varying speeds and volumes of atmosphere to pass across an exposed plurality of wing shaped lift generating airfoils, referred to as sucked flaps (36), at an opening in that duct (70). The volumes of atmosphere will then pass through to a lift amplifying, turbulence reducing, radial, spiral airflow generator (68) and then into thrust vector airfoils (26), which will then pass through the duct (70) again as it forms a circular path (72) back to the sucked flaps (36), where it is then re-circulated. The air pressure flowing over the top of the airfoils is reduced relative to the air pressure below the airfoils causing relatively large amounts of lift to be generated to overcome the force of gravity. Because the entire wing surface area necessary to lift the flying car or aircraft can now fit within the confines of the length, width, and height of a standard freeway-capable motor VTOL aircraft or flying car, there is no need for foldable wings, foldable control surfaces, exposed rotors, exterior wind blasts or other problems associated with prior art helicopters, flying cars, or other VTOL aircraft.

### CROSS-REFERENCE TO RELATED APPLICATIONS

Not applicable

### BACKGROUND

1. Field of Invention

This invention relates to improvements in lift generating systems using relatively low amounts of power to overcome the force of gravity, thereby making vertical takeoff and landing of flying cars and other aircraft practical, efficient and cost effective.

2. Description of Prior Art

Over the past 64 years, inventors have attempted to create a VTOL aircraft or flying car that would be drive-able on highways as well as air-worthy. All attempts have ultimately failed because of the impracticality of wings that have to be folded out or the exposed spinning rotor blades, propellers or jet blasts making them dangerous to pedestrians or other VTOL aircraft or flying cars. As far back as 1923 U.S. Pat. Nos. 1,449,100, 2,502,045, 2,777,649, 2,801,058, 2,966,318, 3,002,709, 3,103,327, 3,477,168, 4,196,877,4,796,836, 5,035,377, 5,115,996, 5,152,478 and 5,575,438 illustrate the use of counter rotating props in a duct for lift generation. None of this prior art contains the keys to flying car success to date. The keys to successful flying cars would be massive amounts of lift for VTOL flight, no exposed rotors, no external jet air blasts, low pedestrian risk, an automatic transition from vertical to high speed horizontal flight, reasonable cost, easy to learn to fly, high safety, practical and convenient without modification. The present invention is an aircraft that can be driven on the road without any modification. The present invention VTOL aircraft or flying car can be traveling on a highway and at the touch of a button, rise off the ground into a flying function without having to stop to modify anything. The same VTOL aircraft or flying car can then fly to a crowded city and land in a parking space vertically.

U.S. Pat. No. 5,687,934 teaches a leading edge slot for blowing and a trailing edge slot for suction on the upper surface of a conventional aircraft wing. The present invention places the entire wing or multiple wings in accelerated, re-circulating airflow.

None of the previous art illustrates a highway capable, aircraft that flies in internal, re-circulated, wind of its own making.

None of the previous art illustrates placing entire airfoils in winds of hundreds of miles per hour for VTOL flight without a corresponding external wind that could affect pedestrians.

None of the previous art teaches the placement of multiple suction airfoils in series producing a lift amplification effect from one airfoil to another in a flying car.

None of the previous art teaches the use of sucked flaps within ducts on pivots for optimizing vertical or horizontal flight automatically.

None of the previous art teaches the secondary lift amplification effect of the “lift amplifying, turbulence reducing, radial, spiral airflow generator” device.

None of the previous art teaches a flying car where the faster the forward speed; the slower the rotors have to spin to maintain altitude and speed.

None of the previous art illustrates a highway capable flying car with a 360-degree thruster and rotational thruster system controlled by a single joystick.

None of the previous art illustrates a highway capable VTOL aircraft or flying car, which is also an aircraft, which is also a seaworthy boat without modification.

None of the previous art teaches a flying car boat with the capability to carry missiles, machine guns or cannons.

None of the previous art teaches a flying car that is invisible to radar or infrared sensors.

None of the previous art teaches a VTOL flying car where the rotors do not lift the car, but rather, simply causes a wind for the car's fixed wings to fly in without forward movement of the car.

### SUMMARY

The present invention creates extremely large amounts of controllable lift in confined areas by placing very large lifting wing surface areas above the confined space of the upper surfaces of a car or other highway VTOL aircraft or flying car for the purpose of lifting the VTOL aircraft or flying car's weight vertically with very little power and low exterior wind speeds. It has a capability to fly in a re-circulating wind, to be used on a highway, and to float upon water.

Objects and Advantages

On a standard fixed wing aircraft, the wings produce the greatest low airspeed lift with the flaps extended. Certain aircraft use multiple blown flaps to further add to the low speed lift performance of lifting wings. The drawback of blown flaps is that they produce large amounts of aerodynamic drag and that the airflow has a tendency to transition from a laminar to a turbulent flow, which reduces efficiency. The present invention, referred to as sucked flaps, uses the best aspects of blown flaps without the associated drag or turbulence. Since the wing shaped lift generated airfoils, referred to as sucked flaps, are inside the suction flow inside the duct, the atmosphere flowing over the wing surfaces is sucked directly into the lift amplifying, turbulence reducing, radial, spiral airflow generator and then into counter rotating spinning blades allowing the airfoils to be relatively turbulence free and effectively amplifying the lift effect at very low airspeed and low energy consumption. This innovation makes it possible to produce enough lift to overcome the weight of the VTOL aircraft or flying car while moving air at a minimal speed. The flow of air will be directed in an enclosed, circular manner around the interior of the VTOL aircraft or flying car to protect pedestrians and VTOL aircraft or flying cars from high-speed airflows.

Additional benefits:

(a) The present invention has the additional benefit of the inherent pendulum type stability of hanging the weight of the aircraft from the lift generating airfoils, referred to as sucked slaps, located at the highest part of the VTOL aircraft or flying car, so that any deviation from the level flight orientation caused by winds, side accelerations and/or thrust vectoring would be automatically countered by the equal but opposite force of gravity.

(b) An additional benefit of the internal rotor system is the gyroscopic stability provided by the two spinning counter rotating blade sets. The faster the blades turn, the more stable the aircraft becomes.

(c) Another benefit of the internal rotor system is the increased efficiency of enclosed ducting around the rotor blades over the current open-air blades of today's helicopters.

(d) Another benefit of the internal rotor system combined with the lift generating airfoils, referred to as sucked flaps, is the fact that the internal rotors never have to lift the full weight of the aircraft, like a helicopter, because the sucked flaps produce large amounts of lift at slow duct wind speeds. The sucked flaps actually lift the aircraft. The spinning rotors only provide the local internal wind in which the sucked flaps work. This takes the pressure off the ducted rotating blades and lowers the forces acting on the ducted glades relative to conventional helicopters that have to lift the entire helicopter's weight on the spinning blades.

(e) Another benefit of the internal rotor system, combined with the lift generating airfoils, referred to as sucked flaps, is the high-speed performance. Present helicopters have a problem at high speeds caused by the fact that the rotor tips of helicopters move forward on one side and rearward on the other side of the helicopter relative to the forward speed of the helicopter. When the forward speed of the helicopter is added to the rotor tip speed on the advancing side of the helicopter, the rotor tip reaches the speed of sound on one side and not on the other, this causes instability and a highly dangerous flight condition. With the internal rotor system combined with the sucked flaps, the internal rotors are protected form the wind speed of the forward motion of the aircraft allowing the VTOL aircraft or flying car to fly very close to the speed of sound without the problems inherent with present helicopters. In fact, because the forward speed of the aircraft increases the left generated by the sucked flaps lift generated airfoils, the need for higher rotor speed actually goes down as the forward speed of the aircraft provides lift with less help from the rotors.

(f) Another benefit of the present invention is the slow speed to high-speed transition of the present invention from high lift to high speed. This is an example of the dual efficiency of this system. At slow speed, the present invention causes a rush of atmosphere at hundreds of miles per hour to be blown and drawn across the sucked flaps causing an estimated 144 tons of lift at 200 miles per hour to lift the approximately 2 ton flying car or aircraft with great vertical acceleration. Much slower wind speeds of approximately 35 miles per hour will result in an estimated 2.5 tons of lift causing the 2 ton flying car or aircraft to gently rise above a crowded street with minimal wind affecting pedestrians or other VTOL aircraft or flying cars. Once the flying car or aircraft has risen high above the pedestrians and other VTOL aircraft or flying cars below, the internal wind speed can be increased to produce an improved rate of climb to rise above buildings. Once above the physical obstructions of the city, the laminar 360-degree thrust vectoring nozzle at the base of the duct controls the direction and speed of the flying car or aircraft. As the laminar 360-degree thrust vectoring nozzle is controlled to cause the internal wind to be directionally forced to the rear of the flying car or aircraft; the VTOL aircraft or flying car starts to accelerate in a forward direction. The laminar 360-degree thrust vectoring nozzle at the base of the duct also controls the direction of flight, the angular attitude of the flying car or aircraft, and the banking of the flying car or aircraft to balance the centrifugal and gravitational force directly under the VTOL aircraft or flying car for passenger comfort during high speed turns. As the flying car or aircraft accelerates forward, the sucked flaps are exposed to the oncoming atmosphere in the form of a high-speed wind rushing over their lift generating surfaces causing speed-induced lift. This speed-induced lift reduces the need for the internal rotors to provide airspeed over the lift generating surfaces. Under this high-speed condition, the rotor pitch can be moved toward the feathered position and the rotor rotational speed can be reduced for energy savings while traveling toward the destination. When the destination is reached, the laminar 360-degree thrust vectoring nozzle is controlled to cause the internal wind to be directionally forced to the front of the flying car or aircraft and the VTOL aircraft or flying car starts to decelerate. As the flying car or aircraft decelerates, the speed-induced lift starts to fade and the internal rotors are moved from a feathered to an active wind generated pitch and the rotational speed of the internal rotors is increased to transformed speed into lift for landing or slow speed movement between tall objects. In a situation where the flying car or aircraft is traveling at a high rate of speed, on a freeway for example, the amount of power required to takeoff would be reduced by the amount of forward speed involved. In a situation where the flying car or aircraft is traveling through the atmosphere and descends onto a freeway for example, the amount of power required for landing would be reduced by the amount of forward speed involved.

(g) Another benefit of the present invention is the military applications of this technology. A military land/sea/air version the preferred embodiment of a VTOL flying car/boat/aircraft in accordance with the present invention could revolutionize the way the military performs its function. The military version would make it possible to place piloted and/or non-piloted VTOL aircraft or flying cars anywhere on land or sea. The military version would virtually provide any application at high speeds, with ability to stop in mid-air, go straight up in a level attitude, go straight down in a level attitude, hide behind terrain, operate in close proximity to foot soldiers, as well as carry supplies, mail, or personnel while not being overly disturbed by external wind forces. A Coast Guard version of the present invention would extend the Coast Guard helicopter role from the sky into the sea with a new type of water landing and take off sea rescue capability. Many other roles for an aircraft with such a variety of functions will become apparent to those

### DRAWING FIGURES

FIG. 1 a is a schematic chart showing an airfoil inside a closed circuit with a propeller or compressor means causing a flow through the oval circuit referred to as the wind circle. FIG. 1b is a schematic chart showing an airfoil in a wind circle having counter-rotating blades as the propeller or compressor means. The propeller compressor means may also be a jet engine, a turbine engine, a bypass turbofan engine or other accelerated airflow device.

FIG. 1c is a schematic chart showing multiple airfoils in a wind circle having counter-rotating blades as the propeller or compressor means.

FIG. 1d is a schematic chart showing multiple airfoils in a wind circle having counter-rotating blades as the propeller or compressor means with a thrust vector slot opening in the direction of the airfoil trailing edges for acceleration function.

FIG. 1e is a schematic chart showing multiple airfoils in a wind circle having counter-rotating blades as the propeller or compressor means with a thrust vector slot opening in the direction of the airfoil leading edges for deceleration function.

FIG. 1f is a schematic chart showing multiple airfoils in a wind circle having counter-rotating blades as the propeller or compressor means with a thrust vector slot having a 360-degree thrusting capability for a 360-degree movement function.

FIG. 1g is a perspective schematic chart showing multiple airfoils in a wind circle with an opening to outside atmosphere having counter-rotating blades as the propeller or compressor means with a prime mover engine to rotate the propeller or compressor means with a thrust vector slot opening in the direction of the airfoil trailing edges for acceleration function.

FIG. 1h is a perspective schematic chart showing additional multiple airfoils in a series in a wind circle with an opening to outside atmosphere having counter-rotating blades as the propeller or compressor means with a prime mover engine inside an aerodynamic shell to rotate the propeller or compressor means with a thrust vector slot opening in the direction of the airfoil trailing edges for deceleration function.

FIG. 1i is a perspective schematic chart that shows the same concept as in FIG. 1h, but includes a cylindrical opening to improve the propeller or compressor function.

FIG. 1j is a perspective schematic chart showing the same concept as in FIG. 1i, but with a set of rotational thrust vector slots for a yaw control function with a turbine engine as the prime mover engine and a piston engine as the highway engine.

FIG. 1k is a perspective schematic chart showing the concepts in FIG. 1j, but includes a variable volume opening slot nozzle at the exit of the wind circle for a high speed back-pressure function and a trim stabilizer elevator for control of the attack angle.

FIG. 1l is a perspective schematic chart showing FIG. 1k with an addition of the lift amplifying, turbulence reducing, radial, spiral airflow generator and accommodation for road engaging wheels.

FIG. 2 is a section view through the longitudinal centerline of preferred embodiment of the present invention.

FIG. 3 is a perspective view of the top and side surfaces of preferred embodiment of the present invention.

FIG. 4 is a perspective view of the bottom and side surfaces of preferred embodiment of the present invention.

FIG. 5 is a section view through the longitudinal centerline of preferred embodiment of the present invention illustrating the slow speed flight configuration of the present invention.

FIG. 6 is a section view through the longitudinal centerline of preferred embodiment of the present invention illustrating the high-speed flight configuration of the present invention.

FIG. 7 is a perspective view of the progressive sucked flaps

FIG. 8 is a perspective view of the lift amplifying, turbulence reducing, radial, spiral, airflow generator.

FIG. 9 is a perspective view of the function of internal airspeed.

FIG. 10 is a section view of the wind circle lift amplification function.

FIG. 11 is a perspective view of the 360-degree thrust vector nozzle and rotational thrust vector nozzle component of the present invention with the joystick that controls its function.

FIG. 12 is a perspective view of the top, side and rear of a land/sea/air military version of the present invention illustrating the military weapons platform function of this VTOL aircraft or flying car.

FIG. 13 is a perspective view of the bottom, side and rear of a land/sea/air military version the present invention illustrating the military weapons platform function of this VTOL aircraft or flying car.

FIG. 14 is a perspective view of the top, side and front of a land/sea/air military version of the present invention illustrating the military weapons platform function of this VTOL aircraft or flying car.

FIG. 15 shows a perspective view of a jet engine powered embodiment of the present invention VTOL flying car or aircraft in a flying limousine application

FIG. 16 shows a perspective view of a jet engine powered embodiment of the present invention VTOL flying car or aircraft in a flying semi truck application.

FIG. 17 shows a perspective view of a jet engine powered embodiment of the present invention VTOL flying car or aircraft in a flying police/ambulance application.

FIG. 18 shows a perspective view of a jet engine powered embodiment of the present invention VTOL flying car or aircraft in a flying cargo truck application.

Reference Numerals in Drawings:

| | | | |
|---|---|---|---|
| 10 | VTOL aircraft or flying car | 58 | collective pitch and speed |
| 12 | an aerodynamic fuselage | | control joy stick |
| 14 | cylindrical opening | 60 | impact absorbing bumper |
| 16 | opening to outside atmosphere | 62 | flight and highway |
| 18 | counter-rotating blades as the | | instruments |
| | propeller or compressor | 64 | variable volume opening |
| | means | | slot nozzle or laminar exit |
| 18 | propeller or compressor | | valve |
| | means | 66 | windscreen |
| 20 | collective pitch control | 68 | a lift amplifying, turbulence |
| 22 | low pressure airflow | | reducing, radial, spiral |
| 24 | high-pressure airflow | | airflow generator |
| | thrust vectoring plenum | | (l.a.t.r.r.s.a.g.) |
| 28 | wind circle duct | 70 | the wind circle, closed |
| 30 | a drive shaft and differential | | circuit |
| 32 | engine transmission | 72 | multiple kinds of lift |
| 34 | prime mover engine | | generating functions |
| 36 | airfoil | | working in a self feeding, |
| 38 | prime engine exhaust | | recirculating, internal |
| 40 | accommodation for road | | airspeed, internal airspeed |
| | engaging wheels | 74 | traps a bubble of |
| 42 | road engaging suspension | | compressed, slow moving |
| 44 | piston engine | | air |
| 44 | secondary road engine | 76 | concave section of the |
| 46 | thrust vector slot having | | leading edge of an airfoil |
| | a 360-degree thrusting | 78 | lift amplifying, tubulence |
| | capability for a 360-degree | | reducing, spiral airflow |
| | movement function. | | generator blades |
| 48 | set of rotational thrust | 80 | thrust vector slot opening |
| | vector slots | | in the direction of the |
| 50 | thrust vector slot opening in | | airflow trailing edges for |
| | the direction of the airfoil | | acceleration function |
| | leading edges for deceleration | 82 | radar return diverting |
| | function. | | fuselage |
| 52 | pilot/drive controls such as | 84 | seaworthy shell or hull |
| | a highway, steering wheel, | 86 | infrared signature cooled |
| | throttle and brake pedals | | engine exhaust vector |
| 54 | 360-degree directional thrust | | nozzle |
| | vector control joy stick | 88 | swept angled sucked flaps |
| 56 | integrated rotational thrust | 90 | radar return deflecting |
| | vector control | | access doors |
| 94 | radar return deflecting | 92 | radar return deflecting |
| | engine intakes | | highway access doors |
| 96 | radar return deflecting | 106 | radar return deflecting |
| | weapons bay access doors | | ejection seat |
| 98 | internal weapons bay racks | 108 | a floor window |
| 100 | projectile weapon | 110 | aircraft carrier hook |
| 102 | explosive deployed | 112 | back-pressure valve |
| | emergency parachutes | 114 | trim stabilizer elevator |
| 104 | aerial refueling access | | for control of the attack |
| | | | angle. |
| | | 118 | air intake |

### DESCRIPTION

Preferred Embodiment

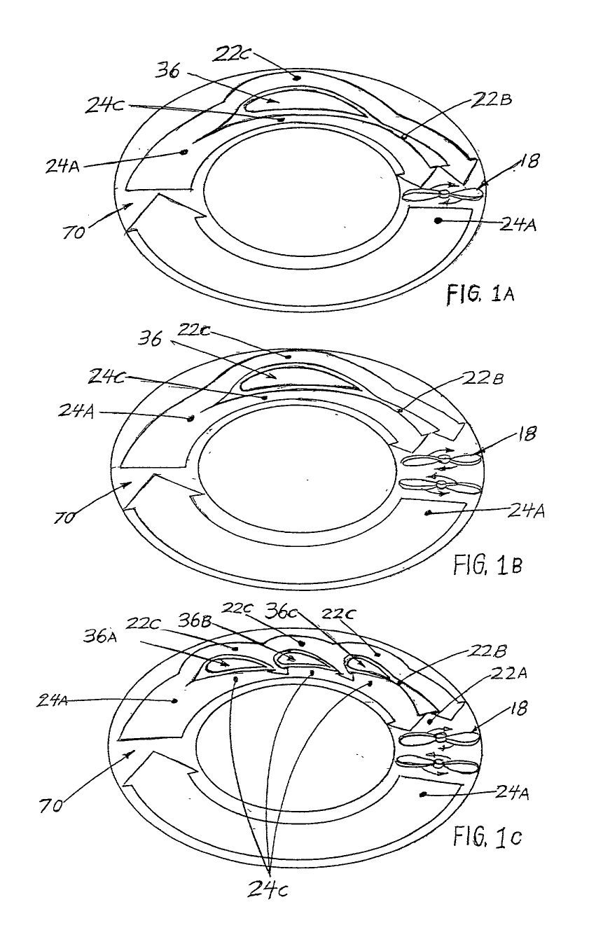

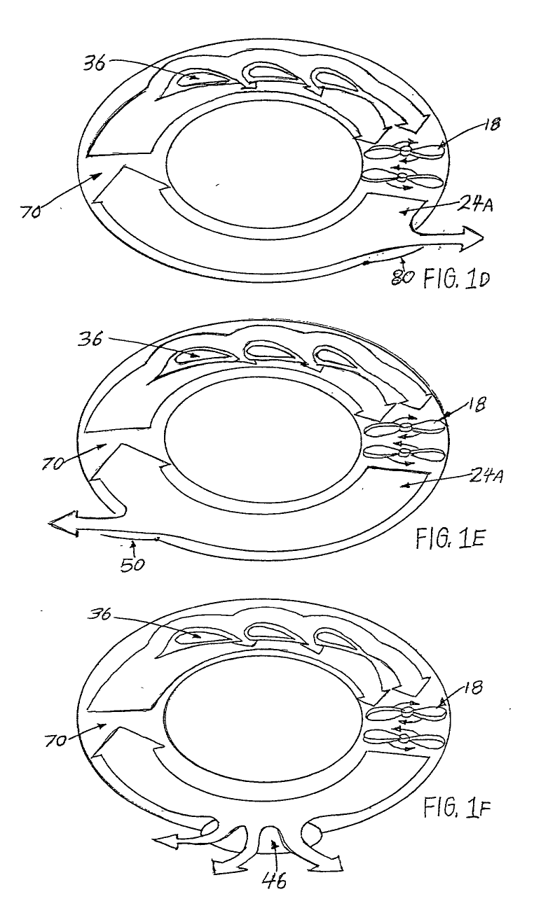

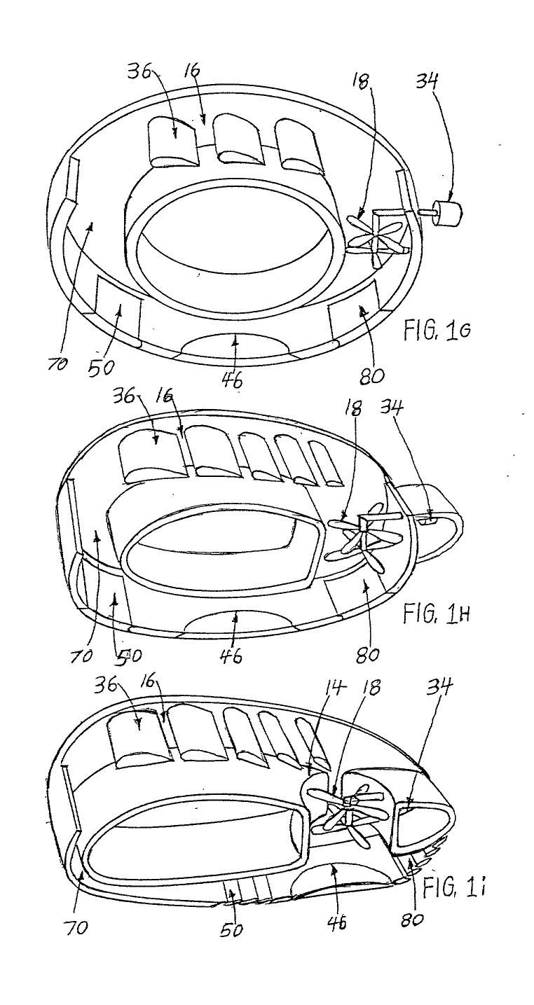

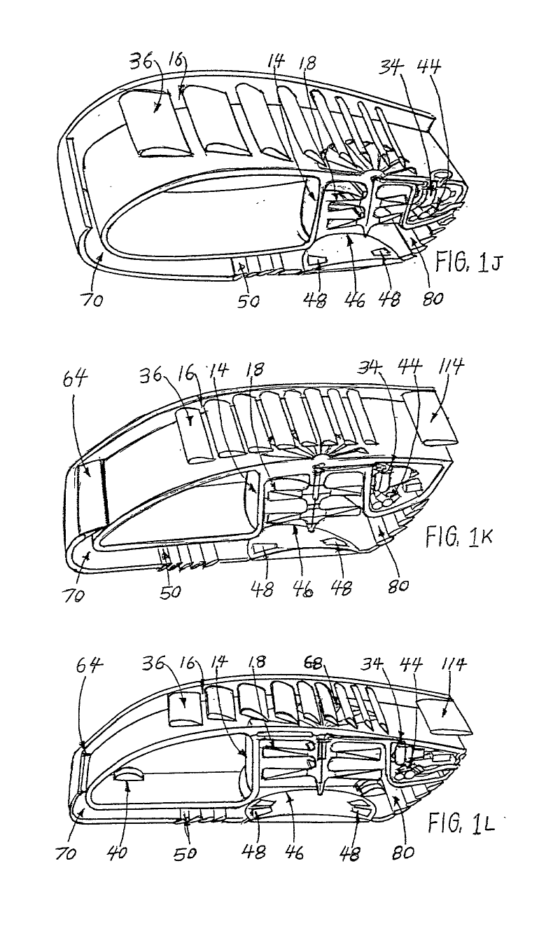

FIG. 1a, FIG. 1b, FIG. 1c, FIG. 1d, FIG. 1e, FIG. 1f, FIG. 1g, FIG. 1h, FIG. 1i, FIG. 1j and FIG. 1l represent the large number of interrelated unique, novel and functional components that work separately or in combination to achieve the goal of creating an efficient, practical, high performance, convenient, low cost, flying car or aircraft which is detailed in the description of the preferred embodiment of the present invention.

FIG. 1a is a schematic chart showing an airfoil 36 inside a closed circuit 70 with a propeller or compressor means 18 causing a flow through the oval circuit referred to as the wind circle 70. A high-pressure airflow 24a is created by the propeller or compressor means 18. A low pressure airflow 22c is created on the suction side of the airfoil 36 and a high pressure airflow 24c on the pressure side of the airfoil 36 causing a pressure differential lift function. The combined airflow from the airfoil 22b is suctioned back into the propeller or compressor means 18 to complete one circuit of the wind circle 70.

FIG. 1b is a schematic chart similar to FIG. 1a, but adds counter-rotating blades as the propeller or compressor means 18.

FIG. 1c is a schematic chart similar to FIG. 1b, but shows having multiple airfoils 36abc in the wind circle 70. Here, the high pressure airflow 24a contacts the multiple airfoils 36 which splits the airflow 24a into a series of low pressure air flows 22c on the suction side of the airfoils 36 and high pressure air flows 24c on the pressure side of the airfoils 36.

FIG. 1d is a schematic chart similar to FIG. 1c, but includes a thrust vector slot opening 80 in the direction of the airfoil trailing edges for acceleration function.

FIG. 1e is a schematic chart similar to FIG. 1c, but includes a thrust vector slot opening 50 in the direction of the airfoil leading edges for deceleration function.

FIG. 1f is a schematic chart similar to FIG. 1c, but includes a thrust vector slot 46 having a 360-degree thrusting capability for a 360-degree movement function.

FIG. 1g is a perspective schematic chart that includes all concepts of FIG. 1d, 1e, and 1f. This figure also shows an opening on the topside to outside atmosphere 16 and a prime mover engine 34 to rotate the propeller or compressor means 18.

FIG. 1h is a perspective schematic chart similar to FIG. 1g, but shows additional multiple airfoils 36 (as in FIG. 1c) in a series in the wind circle 70.

FIG. 1i is a perspective schematic chart similar to FIG. 1h, but includes a cylindrical opening 14 to improve the propeller or compressor function 18.

FIG. 1j is a perspective schematic chart similar to FIG. 1i, but includes a set of rotational thrust vector slots 48 for a yaw control function at the base of the VTOL aircraft or flying car and a piston engine as a highway engine 44.

FIG. 1k is a perspective schematic chart similar to FIG. 1j, but includes a variable volume opening slot nozzle 64 at the exit of the wind circle 70 for a high speed back-pressure function and a trim stabilizer elevator 114 for control of the attack angle.

FIG. 1l is a perspective schematic chart similar to FIG. 1k, but includes a lift amplifying, turbulence reducing, radial, spiral airflow generator 68 and accommodation for road engaging wheels 40.

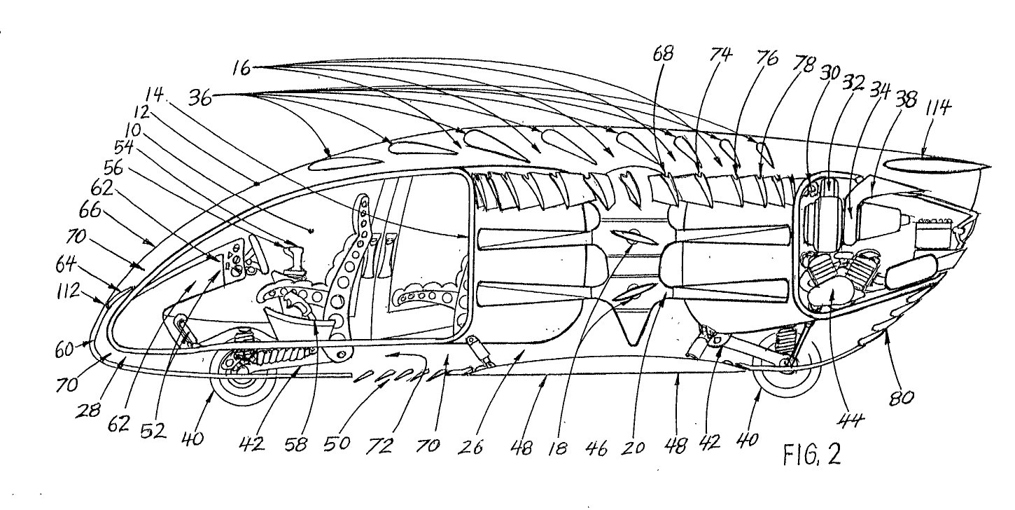

FIG. 2 shows a perspective longitudinal section view of a preferred embodiment of a VTOL aircraft or flying car in accordance with the present invention. Similar to FIG. 1l but includes the preferred embodiment with an aerodynamic fuselage 12, a back-pressure valve 112, multiple kinds of lift generating functions working in a self feeding, re-circulating, internal airspeed 72, an engine transmission 32, a prime engine exhaust 38 a road engaging suspension 42, thrust vectoring plenum 26 to provide pitch, yaw, roll, rotational, acceleration and deceleration forces, a drive shaft and differential to convert horsepower to the proper revolutions per minute through and delivered to the counter-rotating blades, pilot/driver controls such as a highway, steering wheel, throttle and brake pedals 52, a flight, 360-degree directional thrust vector control joy stick 54, integrated rotational thrust vector control 56, collective pitch and speed control joy stick 58, flight and highway instruments 62, and an impact absorbing bumper 60.

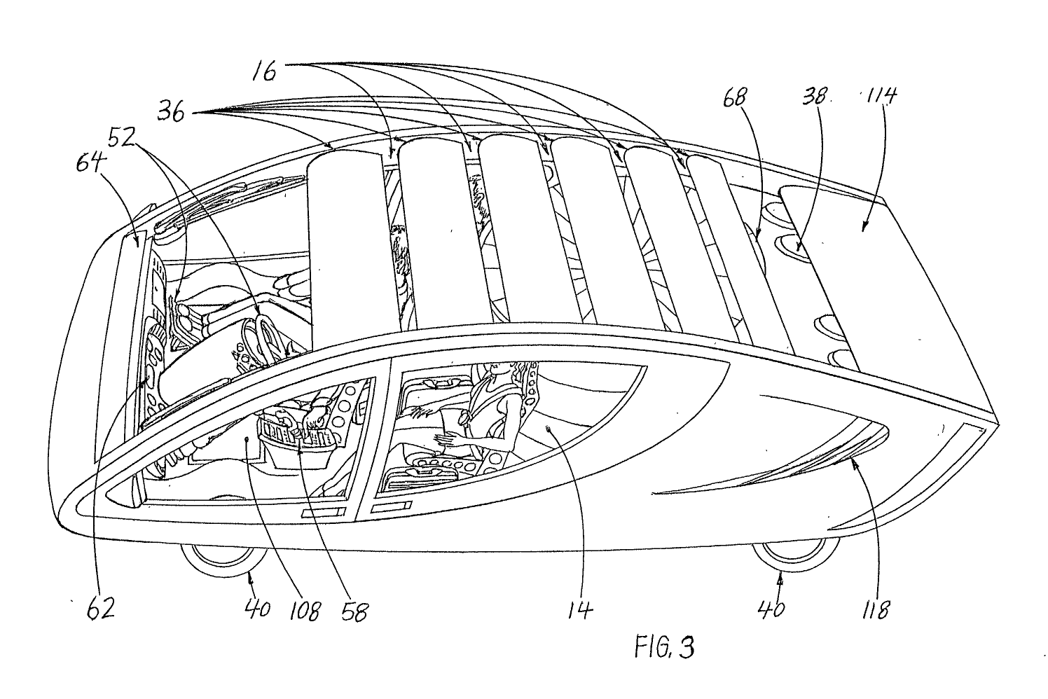

FIG. 3 shows a perspective view of the preferred embodiment of a VTOL aircraft or flying car in accordance with the present invention similar to FIG. 2, but includes an illustration of a floor window 108 for landing and observation and an air intake 118 for the vehicle and aircraft engines.

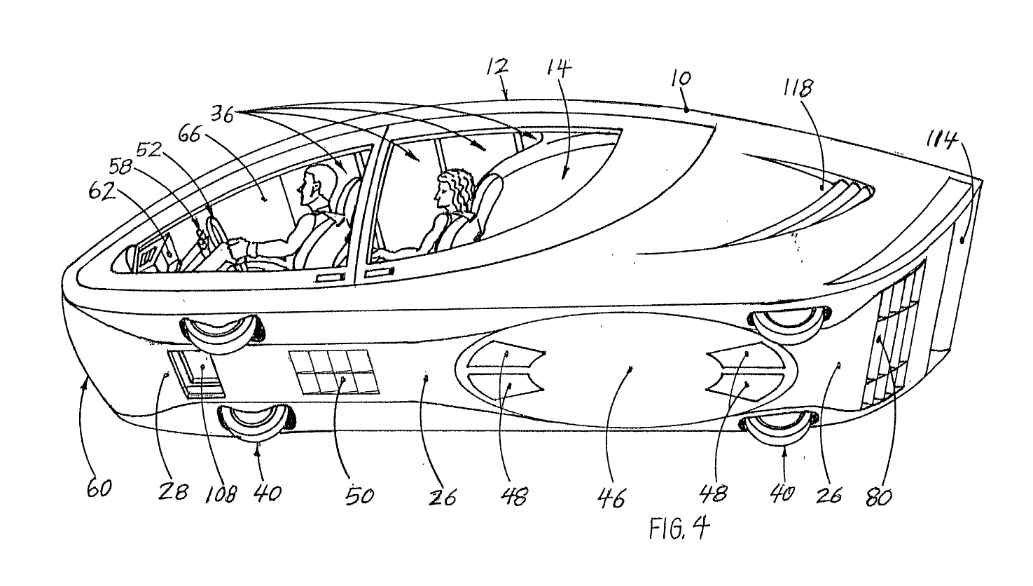

FIG. 4 shows a perspective view of the preferred embodiment of a VTOL aircraft or flying car in accordance with the present invention illustrating the view looking up at the bottom of the said VTOL aircraft or flying car as it rises on the lift provided by the internal wind of its own making.

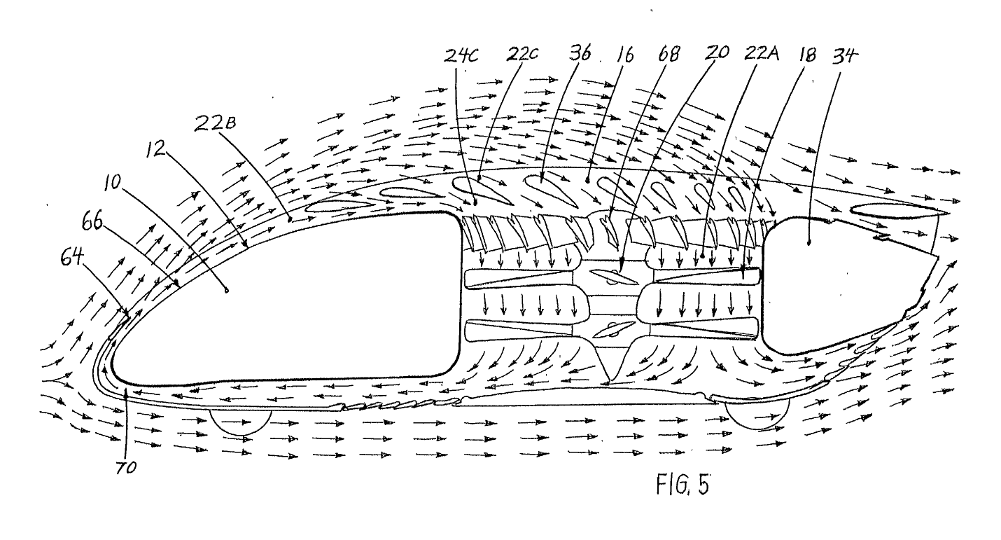

FIG. 5 shows a section view through the centerline of the preferred embodiment of a VTOL aircraft or flying car in accordance with the present invention illustrating low speed flight configuration. Please refer to previous references of labeled figures.

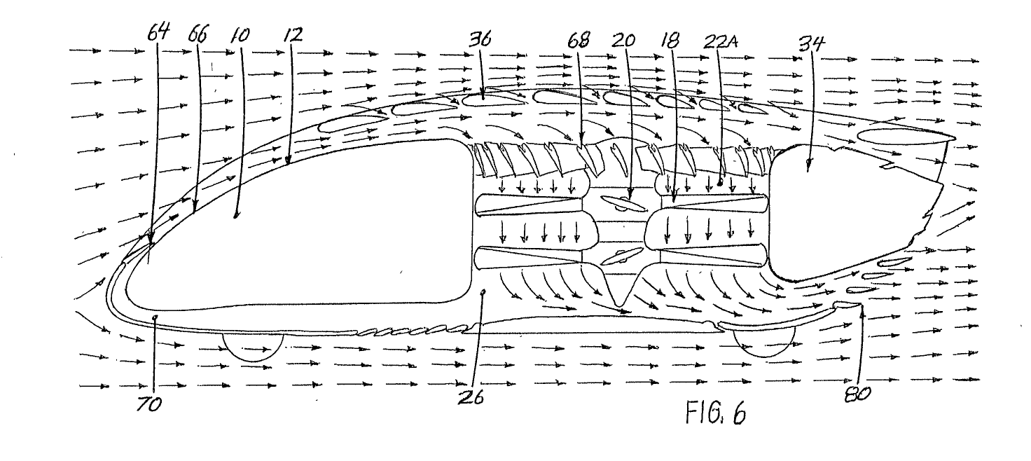

FIG. 6 shows a section view through the centerline of the preferred embodiment of a VTOL flying car or aircraft in accordance with the present invention illustrating high speed flight configuration.

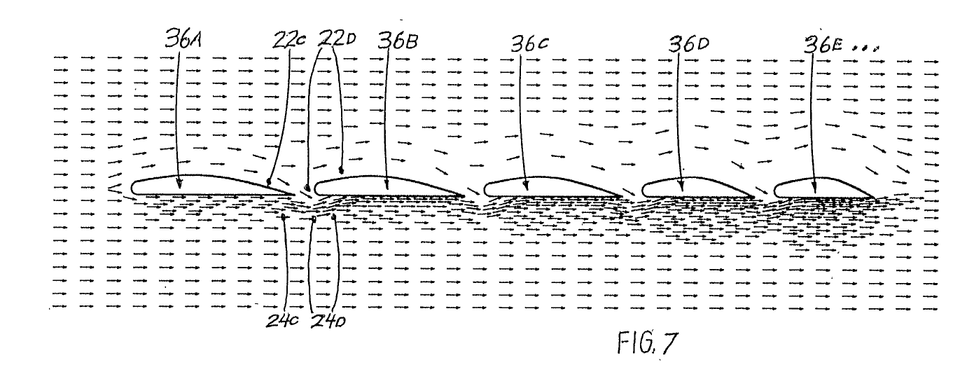

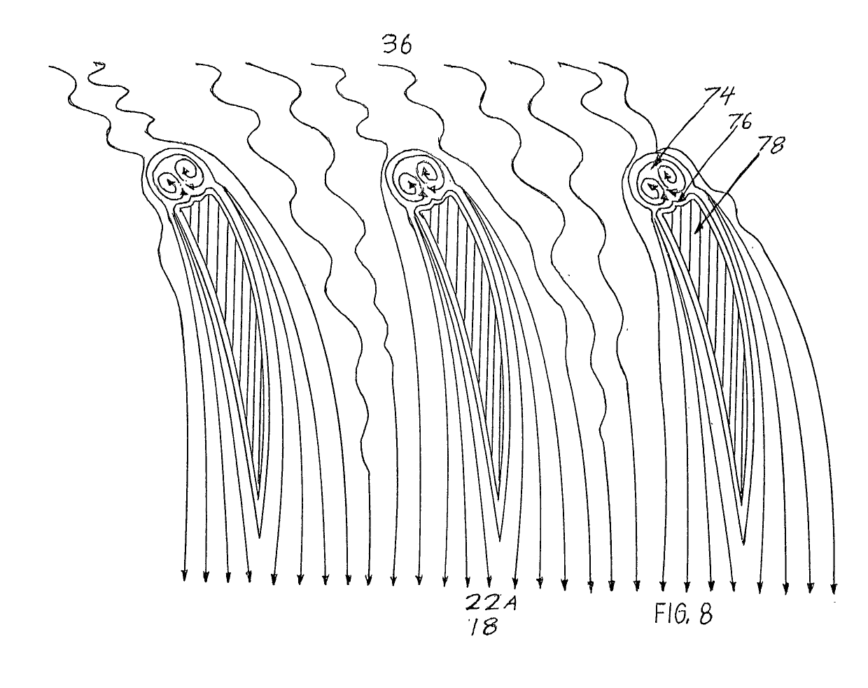

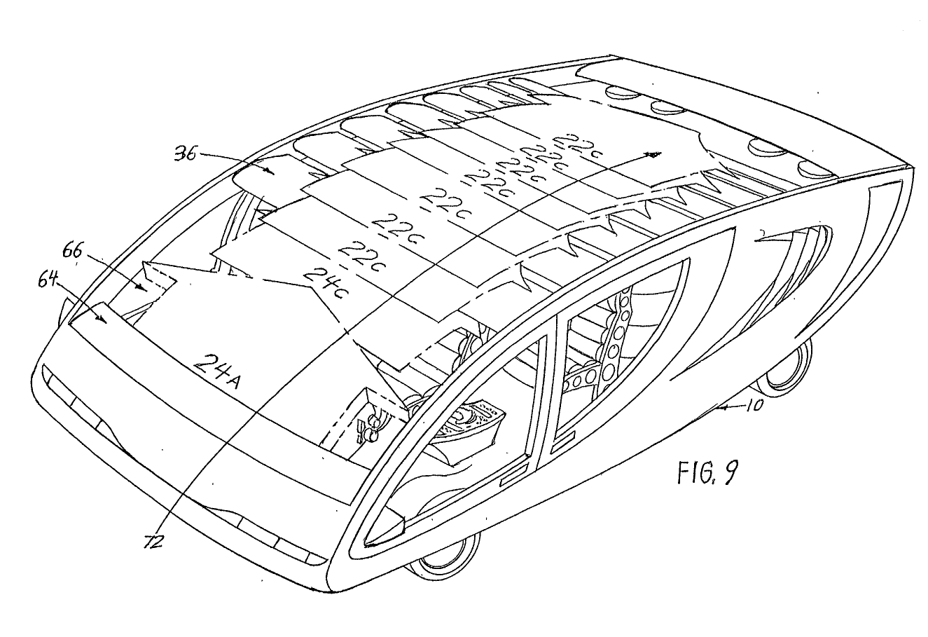

FIG. 7 shows a section view through the centerline of the sucked flap 36 wings of the preferred embodiment of a VTOL flying car or aircraft in accordance with the present invention illustrating the first (1st) of the lift amplifying components referred to as progressive sucked flaps. Progressive sucked flaps 36a, 36b, 36c, 36d, 36e, - - - , indefinitely, occupying a portion of the upper surface of a flying car or aircraft provide an appropriate airfoil lifting area to bang the weight of the flying car or aircraft from within the confined space of the length and width of a VTOL aircraft or flying car sized to operate on highways and in traffic with other VTOL aircraft or flying cars and pedestrians.

FIG. 8 shows a section view through a typical section of the lift amplifying, turbulence reducing, radial, spiral airflow generator 68 component of the preferred embodiment of a VTOL flying car or aircraft 10 in accordance with the present invention illustrating the second (2nd) lift amplifying component referred to as the lift amplifying, turbulence reducing, radial, spiral airflow generator 68. The lift amplifying, turbulence reducing, radial, spiral airflow generator (l.a.t.r.r.s.a.g) 68 component of the present invention automatically converts the linear, turbulent, airflow coming from the sucked flaps 36 into a more laminar, spiral airflow for optimal introduction to the counter-rotating fan blades 18 utilizing the novel concept of suction induced compression where the suction driven airflow 22a traps a bubble of compressed, slow moving air 74 on the concave leading edge 76 of each of the l.a.t.r.r.s.a.g. blades 78.

FIG. 9 shows a perspective view of the preferred embodiment of a VTOL flying car or aircraft 10 in accordance with the present invention illustrating the third (3rd) lift amplifying component referred to as the internal airspeed 72.

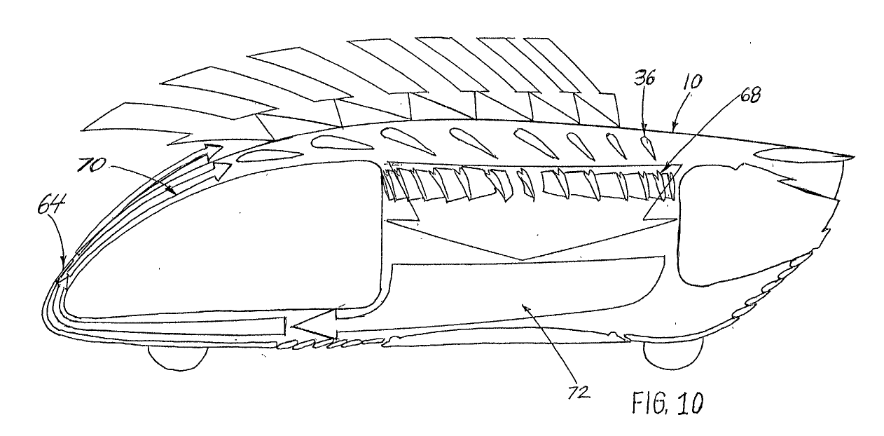

FIG. 10 shows a perspective schematic chart of the preferred embodiment of a VTOL aircraft or flying car in accordance with the present invention illustrating the fourth (4th) lift-amplifying component referred to as wind circle lift amplification.

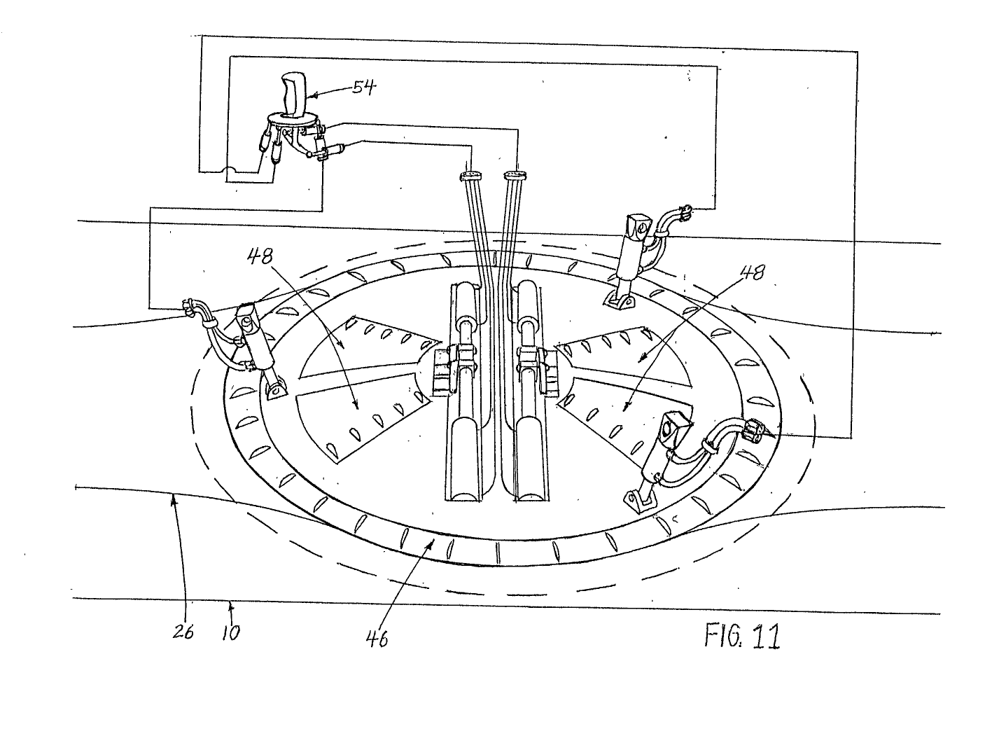

FIG. 11 shows a perspective view of the laminar 360-degree thrust nozzle 46 and joy stick controller 54 components of the preferred embodiment of a VTOL flying car or aircraft 10 in accordance with the present invention illustrating the use of a circular plate valve seated against a circular valve seat opening which is held in place by a plurality of motion actuators to hold a seal on the pressure in the multi-function thrust vectoring plenum 26.

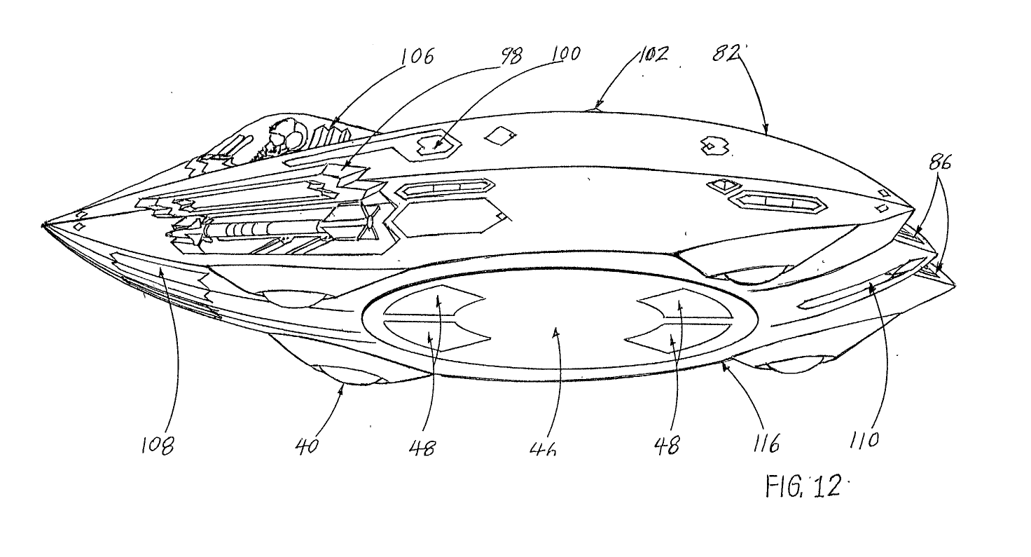

FIG. 12 shows a perspective view of a military land/sea/air version the preferred embodiment of a VTOL flying car or aircraft 10 in accordance with the present invention illustrating the replacement of the aerodynamic lift fuselage 12 with a radar return diverting fuselage 82, and at least the bottom half of the aircraft is made of a one piece, waterproof buoyant, sea worthy shell or hull 84 for landing and taking off from bodies of water. There can be internal weapons bay racks 98 which move out into a launch position and then move back in immediately after the launch, as well as other projectile weapons 100 to be available at the touch of a trigger. In the case of an aircraft carrier landing with low fuel, the aircraft would be provided with a radar return deflecting, low power landing, aircraft carrier hook 110.

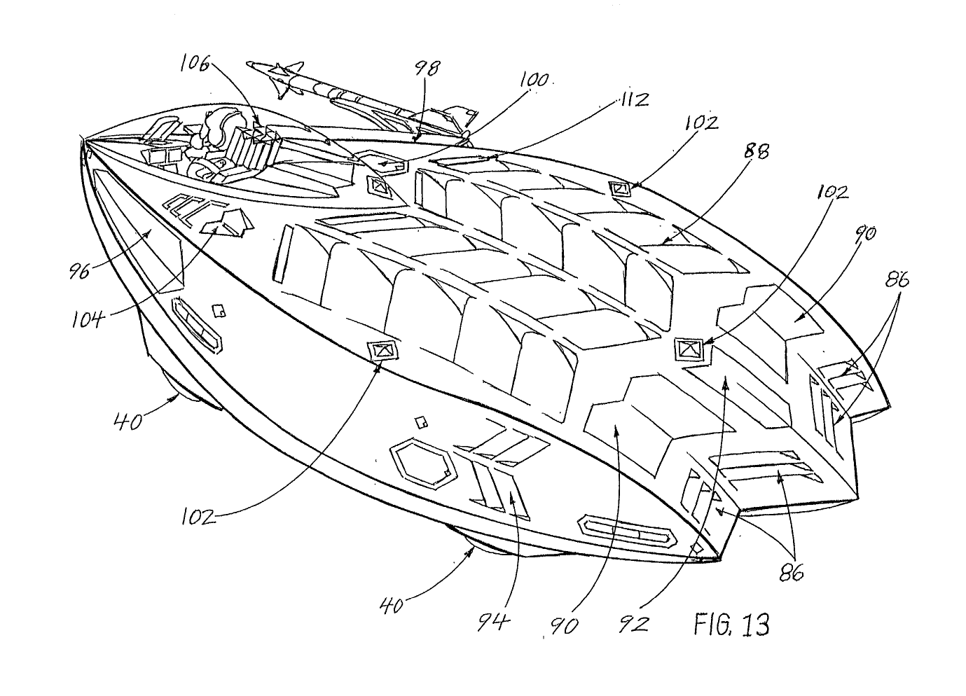

FIG. 13 shows a perspective view of a military land/sea/air version the preferred embodiment of a VTOL aircraft or flying car in accordance with the present invention illustrating more of the military functions. Here, the sucked flaps 36 would be upgraded from straight to swept angle suck flaps 88. There will be a plurality of engines with radar return deflecting access doors 90, which can be locked and sealed for watertight sea operations. The highway engine will also have a radar return deflecting highway access door 92, which also can be locked and sealed for watertight sea operations. The engines will need radar return deflecting engine intakes 94, which are locked and sealed for watertight sea operations. A plurality of explosive deployed emergency parachutes 102 would help protect the crewmen from harm in the event of a mechanical failure.

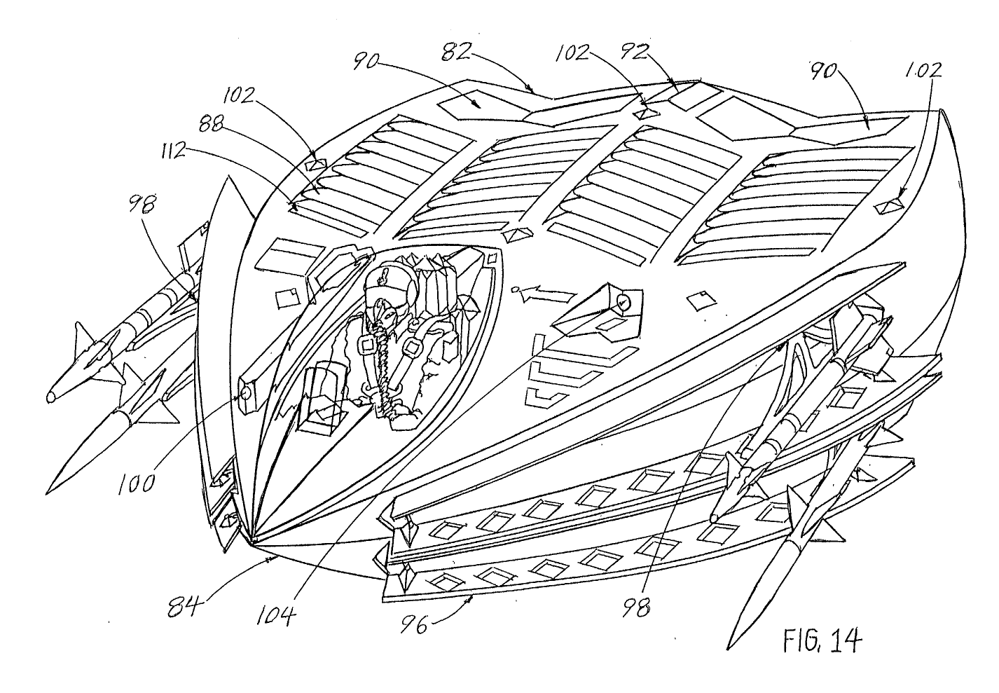

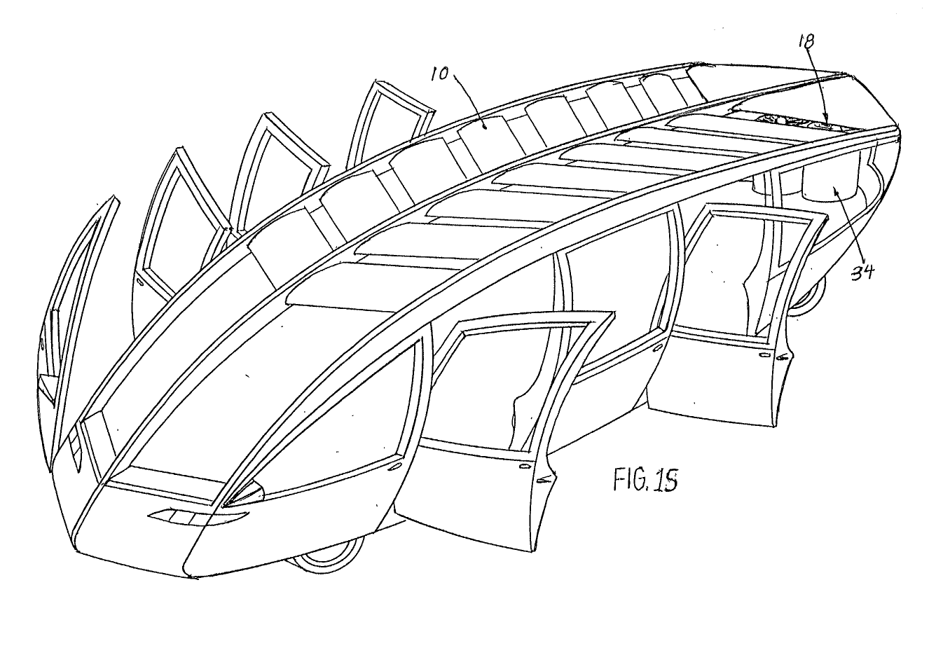

FIG. 14 shows a perspective view of a military land/sea/air version the preferred embodiment of a VTOL flying car or aircraft 10 in accordance with the present invention illustrating the military weapons platform function of this aircraft, which will require radar return deflecting weapons bay access doors 96. There can be aerial refueling access 104 that could extend the range of the aircraft.

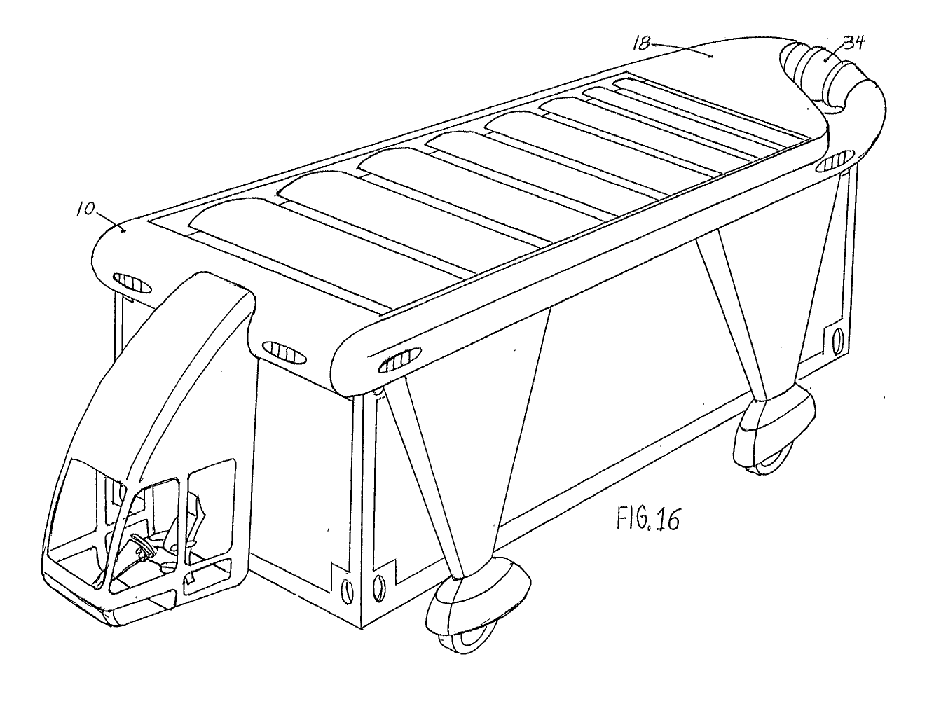

FIG. 15 shows a perspective view of a jet engine 34 powered embodiment of the present invention VTOL flying car or aircraft 10 in a flying limousine application.

FIG. 16 shows a perspective view of a jet 18 engine 34 powered embodiment of the present invention VTOL flying car or aircraft 10 in a flying semi truck application.

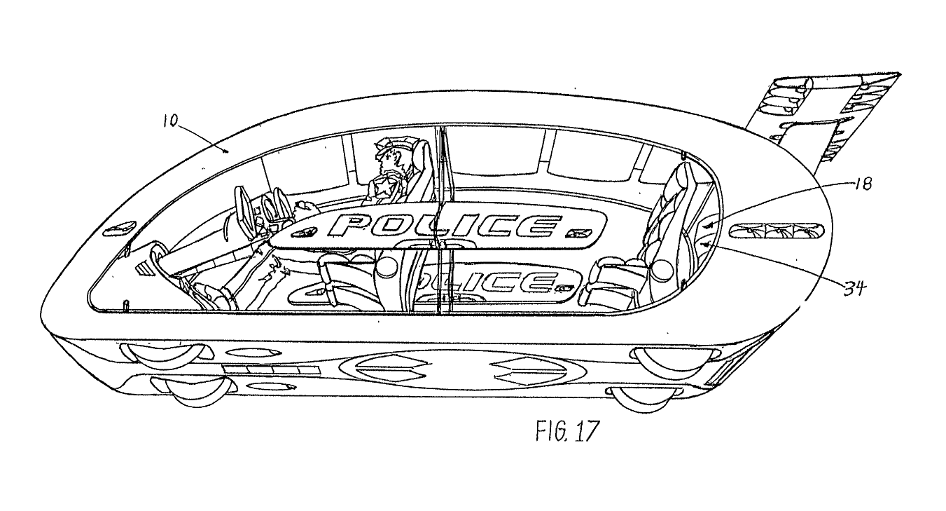

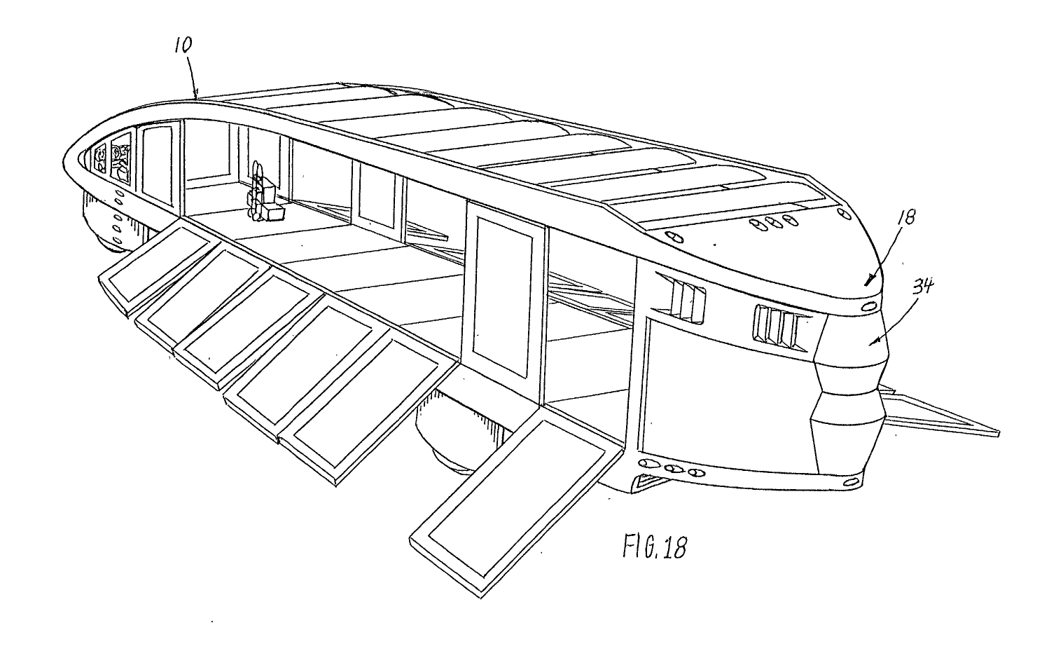

FIG. 17 shows a perspective view of a jet 18 engine 34 powered embodiment of the present invention VTOL flying car or aircraft 10 in a flying police/ambulance application.

FIG. 18 shows a perspective view of a jet 18 engine 34 powered embodiment of the present invention VTOL flying car or aircraft 10 in a flying cargo truck application.

Additional Embodiment

Although the present invention has been described in terms of specific embodiments, it is anticipated that alterations and modifications thereof will no doubt become apparent to those skilled in the art. It is therefore intended that the teachings and drawings that comprise the content of this patent application as well as the following claims be interpreted as covering all such alterations and modifications as fall within the true spirit and scope of the teachings and drawings contained herein as well as the true spirit and scope of the invention claims and the invention itself

Alternative Embodiment

Although the present invention has been described in terms of specific embodiments, it is anticipated that alterations and modifications thereof will no doubt become apparent to those skilled in the art. It is therefore intended that the teachings and drawings that comprise the content of this patent application as well as the following claims be interpreted as covering all such alterations and modifications as fall within the true spirit and scope of the teachings and drawings contained herein as well as the true spirit and scope of the invention claims and the invention itself

Advantages

The present invention can create massive amounts of lift for VTOL flight with no exposed rotors, no external jet air blasts, low pedestrian risk, an automatic transition from vertical to high-speed horizontal flight, and high safety. The present invention can be accomplished for a reasonable cost, it can be easy to learn to fly, as well as being practical and convenient. The present invention is an aircraft that can be driven on the road without any modification. The present invention of a VTOL aircraft or flying car can be used on a highway and at the touch of a button, rise off the ground into a flying function without having to stop to modify anything. The same VTOL aircraft or flying car can then fly to a crowded city and land in a parking space vertically. There are many applications throughout society for this invention.

Operation

a) Operation of the of the Four Main Components

FIG. 7 shows a section view through the centerline of the sucked flap 36 wings of the preferred embodiment of a VTOL flying car or aircraft in accordance with the present invention illustrating the first (1st) of the lift amplifying components referred to as sucked flaps. As depicted, the preferred embodiment shows the sucked flap 36 wings of a VTOL aircraft or flying car in a suction airflow illustrating the lift amplification effect referred to as progressive sucked flaps 36.

One of the aspects of the present invention preferred embodiment illustrates the use of a plurality of lift generating sucked flaps 36 that are positioned on the upper surface of the flying car or aircraft. Said plurality of sucked flaps 36 are arranged with leading edges facing or swept toward the airflow while traveling in a forward direction. This series of sucked flaps 36 starts with the front sucked flap 36 a having a leading edge contacting the airflow first then separating that airflow into a suction airflow and a pressure airflow. After the first sucked flap 36 a has passed through the airflow, the suction airflow 22c and a pressure airflow 24c are allowed to recombine at the trailing edge of the front sucked flap 36a. As these airflows recombine, the high pressure airflow 24c from below moves upward to fill the low pressure, suction, airflow 22c above in an area of low pressure re-combination 22d and high pressure re-combination 24d. At this point, a second sucked flap 36b is positioned to trap this high pressure, upward moving airflow on the underside of the second sucked flap 36b automatically. The top of the second sucked flap 36b is exposed to the low pressure airflow 22d and passes this low pressure airflow over the convex upper surface of the second sucked flap 36b to further lower the airflow pressure relative to the higher pressure below the second sucked flap 36b to result in a greater pressure difference. This progression of each trailing airfoil aligned to take advantage of the lifting effect of the airfoil in front of it is referred to as progressive sucked flaps. Progressive sucked flaps 36a, 36b, 36c, 36d, 36e, —- - - , indefinitely, occupying a portion of the upper surface of a flying car or aircraft provide an appropriate airfoil lifting area to hang the weight of the flying car or aircraft from within the confined space of the length and width of a vehicle sized to operate on highways and in traffic with other vehicles and pedestrians. Because the entire wing surface area necessary to lift the flying car or aircraft can fit within the confines of the length, width and height of a standard freeway capable motor vehicle, there is no need for foldable wings, foldable control surfaces, exposed rotors, exterior wind blasts or other problems associated with prior art helicopters, Harrier type aircraft, tilt rotors, flying cars, or other VTOL aircraft.

Progressive sucked flaps also have a drag reducing benefit. Because the airfoils are in a suction flow, the tendency of air to turn from laminar to turbulent separated flow is reduced by placing the airfoils directly in line with one another. Where the flow would normally separate into a turbulent wake at the trailing edge of a conventional wing, the placement of a second sucked flap 36b airfoil in a suction flow behind the first sucked flap 36a reintroduces a leading edge 36b into the flow.

FIG. 7 shows the leading edge 36b maintaining a separation between the high and low pressure airflows caused by the first airfoil 36a with many advantages. First, the suction flow pulls part of the low pressure airflow off the top of the first airfoil 36a which maintains laminar flow across the entire first airfoil 36a. Second, the remaining low pressure airflow from the first airfoil 36a is passed over the upper surface of the second airfoil 36b which further lowers the pressure of this flow. Third, the high pressure lift below the second airfoil 36b is amplified verses the lower pressure on top of the second airfoil 36b. Fourth, the fact that the two airfoils are in alignment and that the second airfoil 36b is operating in lowered air pressure than the first means that its frontal area drag is reduced. Fifth, since the airfoils 36abcd . . . are in a suction flow, all of the airfoils 36abcd . . . have more laminar flows and are less apt to have wake turbulence than conventional airfoils. Sixth, the lift amplification effect is progressive, meaning that the effect gets more and more pronounced with each additional airfoil 36 in the series of airfoils 36abcd . . . indefinitely.

FIG. 8 shows the present invention with the second (2nd) lift amplifying component referred to as the lift amplifying, turbulence reducing, radial, spiral airflow generator (l.a.t.r.r.s.a.g.) 68. The lift amplifying, turbulence reducing, radial, spiral airflow generator 68 component of the present invention automatically converts the linear, turbulent, airflow coming from the sucked flaps 36 into a more laminar, spiral airflow for optimal introduction to the counter-rotating fan blades 18 utilizing the novel concept of suction induced compression where the suction driven airflow 22a traps a bubble of compressed, slow moving air 74 on the concave leading edge 76 of each of the l.a.t.r.r.s.a.g. blades 78 of the lift amplifying, turbulence reducing, radial, spiral airflow generator 68 This set of trapped bubbles 74 of compressed air on each leading edge of the l.a.t.r.r.s.a.g. blades 78 acts as an automatic shock absorber to absorb the varying forces of the random directions and speeds of impact of a turbulent airflow, and is referred to as turbulence tolerance bubbles 74 A secondary function of the turbulence tolerance bubbles 74 is the tendency of the trapped bubbles of compressed air 74 in each leading edge concave section 76 to spill over the smooth contours of the concave section of the leading edge 76 onto the convex surfaces of the l.a.t.r.r.s.a.g. blades 78 to form a high pressure laminar flow of compressed air expanding into the turbulent flow between the l.a.t.r.r.s.a.g. blades 78 causing an automatic squeezing alignment of the turbulent flow into a laminar flow for more efficient introduction of the airflow into the counter-rotating fan blades 18. The upper surfaces of the l.a.t.r.r.s.a.g. blades 78 can be more convex than the lower surfaces of the l.a.t.r.r.s.a.g. blades 78 causing pressure differential lift of the flying car or aircraft 10.

FIG. 9 shows a perspective view of the preferred embodiment of a VTOL flying car or aircraft 10 in accordance with the present invention illustrating the third (3rd) lift amplifying component referred to as the internal airspeed 72. The internal airspeed 72 function of the present invention involves the creation of a variable airspeed over the internal lift surfaces without a corresponding external airspeed. The internal airspeed effect is accomplished by creating a wind circle 70 where the variable speed airflow over the sucked flaps 36 internal lift surfaces is then suctioned through the lift amplifying, turbulence reducing, radial, spiral airflow generator 68 which automatically converts the linear, turbulent, airflow coming from the sucked flaps 36 into a more laminar, spiral airflow for optimal introduction to the counter-rotating fan blades. These spinning counter-rotating fan blades with variable pitch cause the internal airflow to accelerate into the multi-function thrust vectoring plenum 26 section of the present invention for guidance into the wind circle duct 70, which directs the internal airflow under the vehicle toward the front of the aircraft and around the nose of the aircraft to the base of the windshield 66 where the airflow can be vectored up the windshield 66 to produce a blown lift effect. This blown lift wind is then suctioned back into the sucked flaps 36 at the top of the windshield on the upper surface of the vehicle, causing more lift while passing through the sucked flaps 36, at a higher speed than outside atmospheric speed, then being suctioned at a higher speed with less energy into the lift amplifying, turbulence reducing, radial, spiral airflow generator 68 causing more lift. This wind is then accelerated at a higher speed with less energy by the spinning, counter-rotating blades and is forced back into the in the multi-function thrust vectoring plenum 26 to complete an entire circuit through the wind circle duct 70 to create a high speed, lift amplifying effect without a significant external wind generated.

FIG. 10 shows a perspective schematic chart of the preferred embodiment of a VTOL flying car or aircraft 10 in accordance with the present invention illustrating the fourth (4th) lift amplifying component referred to as wind circle lift amplification, wherein the air moving in the wind circle 70 feeds the airfoils at the front of the sucked flaps 36 lift generating section of the wind circle 70 with high speed, laminar, airflow which reduces the power necessary to keep a constant amount of lift sustained allowing a low power take off and landing configuration during flight operation in close proximity to pedestrians and other vehicles in crowded city streets. As the internal airspeed 72 of the wind circle 70 rises, the weight of the vehicle is transferred from the ground engaging wheels 40 and suspension 42 to the sucked flaps 36 and the lift amplifying, turbulence reducing, radial, spiral airflow generator 68 which are both producing amplified lift which more than offsets the force of gravity which allows the flying car or aircraft to rise off the ground. In fact, some external air is entrained into the wind circle 70 by the suction in the duct causing a compression effect behind the laminar back-pressure valve nozzle 64. This compression amplifies the speed of the wind moving into the lift generating section of the flying car or aircraft 10, which amplifies the lift.

b) Controls of the Components

FIG. 11 shows a perspective view of the laminar 360 thrust nozzle 46 and joy stick controller 54 components of the preferred embodiment of a VTOL flying car or aircraft 10 in accordance with the present invention illustrating the use of a circular plate valve seated against a circular valve seat opening which is held in place by a plurality of motion actuators to hold a seal on the pressure in the multi-function thrust vectoring plenum 26. When the pilot moves the joystick forward, it puts pressure on the control switches for the two actuators that open the rear edge of the circular plate valve which allows high pressure airflow from the multi-function thrust vectoring plenum 26 to be forced out the rear of the flying car or aircraft 10 causing a forward acceleration. Pilot movement of the joy stick 54 in any direction causes the flying car or aircraft 10 to move in that direction for 360-motion control. Pilot rotation of the joy stick puts pressure on the control switches for the actuators that cause the rotational thrust vector nozzles 48 to alternatively open causing the high pressure airflow from the multi-function thrust vectoring plenum 26 to be forced out the rotational thrust vector nozzles 48 in a clockwise or counter-clockwise manner which causes a rotational acceleration of the flying car or aircraft 10 for yaw control.

c) Components Operating at Various Speeds

The preferred embodiment shows a VTOL aircraft or flying car 10 having an aerodynamic fuselage 12 with an atmosphere inlet 16 on the upper surface of the vehicle. The atmosphere inlet 16 contains a number of sucked flap lift generators 36 within the opening of a duct 14 which also may contain a lift amplifying, turbulence reducing, radial, spiral airflow generator 68 where the turbulent airflow sucked through the sucked flap lift generators 36 is converted to a more laminar, spiral, compressed, airflow for introduction into the spinning counter-rotating blades 18 with collective pitch control 20 that when spinning with an appropriate pitch will produce moving atmosphere that draws a suction flow 22a from one side and creates a pressurized flow 24a on the other side. This pressurized flow 24a enters the thrust vectoring plenum 26 where it has multiple options for multiple functions:

One of the options is to direct the pressurized flow 24a into the wind circle duct 70 where the pressurized flow 28 is piped around the nose of the fuselage 12 passing by the back-pressure valve 112 and through the wind circle laminar exit nozzle 64 to send a high speed, blown lift, airflow up the windscreen 66 to reenter the suction flow 22b in the atmospheric inlet where the high speed flow is suctioned around the sucked flap lift generators 36 which separate the airflow into a suction area 22c on top of the sucked flap lift generators 36 and a pressure area 24c on the bottom of the sucked flap lift generators 36 causing a pressure differential lift function as the airflow then passes into the Lift Amplifying, Turbulence Reducing, Radial, Spiral Airflow Generator 68 where the turbulent airflow sucked through the sucked flap lift generators 36 is converted to a more laminar, spiral, compressed, airflow for reintroduction to the spinning counter-rotating blades 18 to form a wind circle 70 which circulates airflow around and around the lift, power and duct sections of the flying car or aircraft 10 to produce a lift amplifying effect of multiple kinds of lift generating functions working in a self feeding, re-circulating, internal airspeed 72.

Another function of the thrust vectoring plenum 26 is to provide pitch, yaw, roll, rotational, acceleration and deceleration forces through a device referred to as the laminar 360 degree thruster 46 and/or rotational thrust vector blades or vector nozzles 48 and/or laminar preload braking thrust vector nozzles 50. Such thrust vectoring plenum 26 provides pressurized airflow directed in an opposite direction to the desired direction of movement to create an airborne 360-degree aircraft movement control system. The power to move this wind circle 70 comes from a prime mover engine 34 which converts fuel into torque and horsepower which are converted to the proper revolutions per minute through an engine transmission 32 and delivered to the counter-rotating blades through a drive shaft and differential 30. When the prime mover engine 34 accelerates, the engine exhaust 38 provides a nose-up pressure to partially counteract the nose-down rotational forces caused by the wind circle 70 movement referred to as internal airspeed 72.

FIG. 5 shows the present invention operating at low speed flight configuration. As depicted, the preferred embodiment shows a VTOL aircraft or flying car 10 with an aerodynamic fuselage 12 illustrating the airflow through the invention. The prime mover engine 34 powers the spinning counter-rotating blades 18 with collective pitch control 20 that when spinning with an appropriate pitch will produce moving atmosphere that draws a suction flow 22a, which pulls in atmosphere through the atmospheric inlet 16 where the high speed flow is suctioned around the sucked flap lift generators 36. This separates the airflow into a suction area 22c on top of the sucked flap lift generators 36 and a pressure area 24c on the bottom of the sucked flap lift generators 36 causing a pressure differential lift function as the airflow then passes into the lift amplifying, turbulence reducing, radial, spiral airflow generator 68. Some of the airflow, however, passes the prime mover engine exhaust ports 38 and passes over the elevator stabilizer wing 114 to help set the angle of attack at higher speeds. The turbulent airflow caused by the progressive sucked flap lift generators 36 is converted to a more laminar, spiral, compressed, airflow by the l.a.t.r.r.s.a.g. blades for introduction to the spinning counter-rotating blades 18. The spinning counter-rotating blades, in turn, pressurize the airflow directed through the thrust vectoring plenum 26 into the wind circle 70 duct then through the laminar exit valve 64 to send a high speed, blown lift, airflow up the windscreen 66 to reenter the suction flow 22b in the atmospheric inlet where the high speed flow is suctioned around the sucked flap lift generators 36 to produce a large amount of upward lift for climbing to altitudes of thousands of feet. Note that the variable volume opening slot nozzle 64 is at a variable opened position.

FIG. 6 shows the present invention operating at a high speed flight configuration. At high speed, the sucked flaps 36 are placed in a horizontal, progressive flaps mode, by the horizontal direction of the oncoming speed induced wind. As depicted, the preferred embodiment shows a VTOL aircraft or flying car 10 with an aerodynamic fuselage 12 illustrating the airflow through the invention. The prime mover engine 34 powers the spinning counter-rotating blades 18 with collective pitch control 20 that when spinning with an appropriate pitch will produce moving atmosphere that draws a suction flow 22a, which pulls in atmosphere from the oncoming, speed induced airflow. Some of the airflow passes the prime mover engine exhaust ports 38 and passes over the elevator stabilizer wing 114 to help set the angle of attack at higher speeds. However, most of the high speed flow is suctioned around the lift amplifying, turbulence reducing, radial, spiral airflow generator 68 where the high speed airflow is converted to a more spiral, compressed, airflow for introduction to the spinning counter-rotating blades 18, which, in turn, pressurizes a closed wind circle duct 70 by means of a closed laminar exit valve 64 at the base of the windshield 66. The closed laminar exit valve causes a high degree of back-pressure in the thrust vectoring plenum 26; this back-pressure is directed out the rear of the flying car or aircraft 10 through the laminar acceleration thrust vector nozzle 80 to produce a large amount of forward acceleration for speeds of hundreds of miles per hour. Note again that the variable volume opening slot nozzle 64 is in the closed position, which is different than when the present invention is operating at a low speed flight configuration.

When operating on the ground, the flying car or aircraft 10 utilizes a number of ground engaging road tires 40, which are connected to the flying car or aircraft 10 by a road engaging suspension 42. A secondary road engine 44 powers the flying car or aircraft 10 when operating on the ground.

Details of the passenger compartment (FIGS. 2, 3, and 4) include a floor window 108 for landing and observation, a left hand control console containing the prime mover control stick 58, the steering wheel and pedals 52, the flight and highway instrument panel 62 and the cylindrical duct 14. Control and monitoring of the road engaging wheels and the flight systems equipment is maintained through the use of pilot/driver controls, such as a highway, steering wheel, throttle and brake pedals 52 and a flight, 360-degree directional thrust vector control 54 joy stick with an integrated rotational thrust vector control 56 and a collective pitch and speed control joy stick 58 and flight and highway instruments 62. In order to meet highway safety standards, the flying car or aircraft is equipped with an impact absorbing bumper 60 to protect the passengers from collision with other vehicles while on the road. An air intake 118 for the prime mover engine 34 and the highway engine 44 is provided with waterproof seal doors for water landings. Furthermore, as a safety precaution, a second prime mover engine 34 could be added to provide a controlled landing should one engine fail. Also, as an additional safety precaution, a number of ballistic or other safety parachute mechanisms 102 could be added to reduce landing speeds.

d) Components Operating in VTOL

As the internal airspeed 72 of the wind circle 70 rises, the weight of the vehicle is transferred from the ground engaging wheels 40 to the sucked flaps 36 and the lift amplifying, turbulence reducing, radial, spiral airflow generator 68, which are both producing amplified lift which more than offsets the force of gravity and allows the flying car or aircraft to rise off the ground.

As the flying car or aircraft rises slowly off the ground at the minimum virtual airspeed of the internal airspeed 72 for flight, the proximity to pedestrians and other vehicles becomes less and the internal airspeed 72 can be increased by varying the pitch and/or speed of the counter-rotating blades 18 to provide larger amounts of lift for improved rates of climb into higher altitudes above the ground. When sufficient altitude is reached to avoid any obstacles such as tress and buildings, the multi- function thrust plenum 26 can be adjusted to direct an increasing amount of airflow from the wind circle duct 70 to the rear of the aircraft causing a forward acceleration of the flying car or aircraft. As the flying car or aircraft accelerates forward, the sucked flaps 36 are exposed to the oncoming atmosphere in the form of a high-speed wind rushing over their lift generating surfaces causing speed-induced lift. This speed-induced lift reduces the need for the internal rotors 18 to provide airspeed over the sucked flap lift generating surfaces. Under this high-speed condition, the rotor pitch can be moved toward the feathered position and the rotor rotational speed can be reduced for energy savings while traveling toward the destination. In this way, high peed flight uses less power per mile. When the destination is reached, control of the multi-function thrust plenum 26 causes the internal wind 72 to be directionally forced through the wind circle duct 70 to amplify the low speed lift and the laminar braking preload nozzle 50 is opened to produce a forward thrust of airflow to slow down the flying car or aircraft using an aerodynamic thrust reverser braking effect. As the flying car or aircraft 10 decelerates, the speed-induced lift starts to fade and the internal rotors 18 are moved from a close to feathered to an active wind generating pitch and the rotational speed of the internal rotors 18 is increased, while the laminar exit valve 64 is opened, to transform forward speed into lift for slow speed, controlled, movement between city buildings or trees to descend for a controlled, low speed, vertical landing.

### CONCLUSION, RAMIFICATIONS, AND SCOPE

The keys to successful flying cars would be massive amounts of lift for VTOL flight, no exposed rotors, no external jet air blasts, low pedestrian risk, an automatic transition from vertical to high speed horizontal flight, reasonable cost, easy to learn to fly, high safety, practical and convenient without modification. The present invention embodies those keys to successful flying cars. It is an aircraft that can be driven on the road without any modification. The present invention VTOL aircraft or flying car can be traveling on a highway and at the touch of a button, rise off the ground into a flying function without having to stop to modify anything. The same VTOL aircraft or flying car can then fly to a crowded city and land in a parking space vertically.

What is claimed is:

1) A VTOL aircraft or flying car comprising (a) the capability of flying in re-circulating wind of its own making and (b) a plurality of ground engaging wheels for highway use and (c) a capability of floating in water.

2) The VTOL aircraft or flying car as defined in claim 1, where a plurality of fan and/or compressor means, which produce a movement of atmosphere that create a suction airflow over a plurality of successive fixed wing and/or movable airfoils on the upper surface of the VTOL aircraft or flying car with leading edges facing or swept toward the forward flight direction of the VTOL aircraft or flying car that has an aerodynamic fuselage, is used in order to separate the atmosphere moving past the airfoils into high pressure atmosphere on the lower side of the airfoils and low pressure on the upper side of the airfoils causing lift to provide vertical take off and landing capability.

3) The VTOL aircraft or flying car as defined in claim 2 wherein the airflow suctioned in through the lift generating wings or flaps by the moving fan or compressor means is ducted back to the inlet of the lift generating wings or flaps to form a circular movement of air within a wind circle duct, which can be accelerated to produce another lift amplification effect, referred to as internal airspeed, to allow the VTOL aircraft or flying car to fly with very low power requirements whereby the corresponding external wind may not effect pedestrians and other objects in close proximity to the VTOL aircraft or flying car.

4) Said circular atmosphere flow as defined in claim 3 wherein a portion of the air traveling in the circular duct can be diverted by the opening of a slot to form a jet of high pressure moving air out from the front of the VTOL aircraft or flying car, creating an aerodynamic braking function while maintaining the circular internal airspeed lift amplification function.

5) Wherein the re-circulating air flow of the VTOL aircraft or flying car as defined in claim 3, the turbulent atmosphere re-circulated from the said plurality of successive wings or foils is converted to a more turbulence reduced, radial, spiral airflow by passing over traps of compressed, slow moving air on the concave leading edge of blades that are positioned to introduce high-pressure, turbulence-reduced, laminar flow of compressed air to the moving fan or compressor means

6) The VTOL aircraft or flying car as defined in claim 2 optimizes vertical and/or horizontal flight through the use of sucked flaps within ducts positioned throughout the VTOL aircraft or flying car.

7) The VTOL aircraft or flying car as defined in claim 2, wherein the highway capable flying car has a 360-degree thruster and rotational thruster system controlled by a single joystick.

8) The VTOL aircraft or flying car as defined in claim 2, wherein the VTOL aircraft or flying car utilizes a jet engine, a turbine engine, a supercharger, a gear pump, a vane pump, an impeller or any other fluid moving device as a propeller or compressor means or prime mover means.

9) The VTOL aircraft or flying car as defined in claim 2 wherein a plurality of atmosphere flow deflecting ducts, slots, vanes, valves, and/or airfoils for producing variable direction and amplitude thrust for controlling the yaw, pitch, roll, rotation, acceleration and deceleration of the flying car or aircraft for transition to and from directional flight.

10) Said plurality of successive wings or flaps as defined in claim 2, wherein those fixed wings and/or movable flap airfoils are arranged in a non-touching tip to tail series having the appropriate gap between the airfoils to suction the low pressure boundary layer of airflow off the top of the front airfoil for mixing with the high pressure boundary layer of airflow from the bottom the front airfoil where the high pressure airflow rushes up to fill the low pressure airflow causing an upward pressure under the second airfoil to produce a lift amplification effect.

11) The positioning of said fixed and/or movable flap airfoils as defined in claim 10 wherein the lift amplification effect of the series of airfoils working in cooperation with one another can produce the upward force to fly the VTOL aircraft or flying car while using relatively slow internal airspeeds, no external airspeed and low engine power to lift large amounts of weight without the long spinning blades or high speed air blasts of previous art.

12) The VTOL aircraft or flying car as defined in claim 2 has a variety of uses in the military sector, government sector, and public sector, wherein the highway capable vehicle, which is also an aircraft, is also a seaworthy boat that can carry a multitude of instruments and devices.
